(19) United States
(12) Patent Application Publication
(10) Pub. No.: US 2015/0143254 A1
(43) Pub. Date: May 21, 2015

(54) DISPLAYING CONTEXT-RELATED BUSINESS OBJECTS TOGETHER WITH RECEIVED ELECTRONIC MAIL (E-MAIL) MESSAGES

(71) Applicant: LENOVO ENTERPRISE SOLUTIONS (SINGAPORE) PTE. LTD., New Tech Park (SG)

(72) Inventors: Barry A. Kritt, Raleigh, NC (US); Sarbajit K. Rakshit, Kolkata (IN)

(21) Appl. No.: 14/083,701

(22) Filed: Nov. 19, 2013

(51) Int. Cl. H04L 12/58

(52) U.S. Cl. CPC H04L 51/046
USPC 715/752

(57) ABSTRACT

When an E-mail message is transmitted to receiving display terminals, there is provided a set of suggested business objects developed by a method comprising profiling the person sending the E-mail message and the person receiving the E-mail message, extracting key words from E-mail message content, performing a semantic analysis of E-mail content and correlating the profiling, extracted key words and semantic analysis to provide the set of suggested business objects.

### TECHNICAL FIELD

The present invention relates to business intelligence systems and particularly to systems users to interactively manipulate displayed business objects to perform ad-hoc business analyses and reports created from the object manipulation.

### BACKGROUND OF THE INVENTION

Most business intelligence systems enable the user to interactively manipulate displayed business objects for ad-hoc analysis and report generation. A recognized difficulty in such manipulations is the great numbers of such objects that may be used. The finding and selection of suitable business objects by users has been time consuming and inefficient to the user and user's resources. As all aspects of business interrelations have become global, business communication has been advancing in putting business information in a form that is easier to communicate and transcends language, cultural and societal differences between people in widespread and global business relationships. Intelligent business objects are being developed that can be readily combined and manipulated, very often on an ad-hoc basis to provide new or combined business objects that readily lend themselves to graphic diagramming and charting that provide working displayed material that is easier to understand and often minimizes language barriers. Intelligent business object systems are commercially available under trade names such as Microstrategy, MS, OLAP, Cognos and Business Objects.

A major problem is that in global interconnected information libraries and warehouses there are exhaustive, almost infinite, numbers of intelligent business objects that may be accessed. Programs are available that process unstructured text as in an E-mail, texting or Web page text to filter terms in text against the background within which the text is being sent wherein intelligent business objects of interest are offered to the communicating transaction.

### SUMMARY OF THE INVENTION

The present invention relates to an E-mail distribution network with user access via a plurality of data processor controlled interactive display terminals and provides for displaying business objects related to the context of received E-mail messages together with the E-mail messages.

When an E-mail message is transmitted to a display terminal, there is provided a set of suggested business objects to said display terminal receiving the E-mail message. This set of suggested business objects is developed by the method comprising profiling the person sending the E-mail message and the person receiving the E-mail message, extracting key words from E-mail message content, performing a semantic analysis of E-mail content and correlating the profiling, extracted key words and semantic analysis to provide the set of suggested business objects.

The set of suggested business objects are displayed together with the E-mail message at a receiving display terminal and a user at the receiving display terminal is enabled to interactively add or remove business objects to create an ad-hoc business analysis report. In order to provide the set of business objects, the invention may further involve analysis of the content of the E-mail messages threaded to the E-mail message. The correlation to provide the business objects may preferably include correlating the profiling, extracted key words and semantic analysis to provide the E-mail message context and comparing the E-mail message context to a universal set of business objects to provide the specific set of suggested business objects.

Furthermore, the performed semantic analysis may be ontology based including data mining. The ontology based semantic analysis may also involve accessing data from a data warehouse (DW) associated with the receiving display terminal.

Also, a set of most frequently used universal business objects may be displayed together with the received E-mail message and the set of suggested objects.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a very generalized view of portions of a network, e.g. Web, for E-mail distribution showing how appropriate intelligent data objects may be accessed from a data warehouse to be displayed, i.e. offered, for use to the user receiving the E-mail message;

FIG. 2 is a block diagram of a data processing system including a central processing unit and network connections via a communications adapter that is capable of functioning as a user's computer controlled display station and as a Web server at the receiving site;

FIG. 3 is a generalized diagram of the display screen at a receiving user's display screen illustrating the displayed E-mail message together with a set of suggested business objects;

FIG. 4 is a display screen like that of FIG. 3 in which the E-mail content has been analyzed and a graph has been developed and is displayed as part of an ad-hoc report;

FIG. 5 is a display screen like that of FIG. 3 in which the user has input additional information responsive to which another graph has been developed and displayed ad-hoc based upon this user supplementary information; and

FIG. 6A-B is an illustrative flowchart describing the running of the process of the present invention for showing how suggested intelligent data objects may be displayed together with the E-mail message.

### DETAILED DESCRIPTION OF THE PREFERRED EMBODIMENT

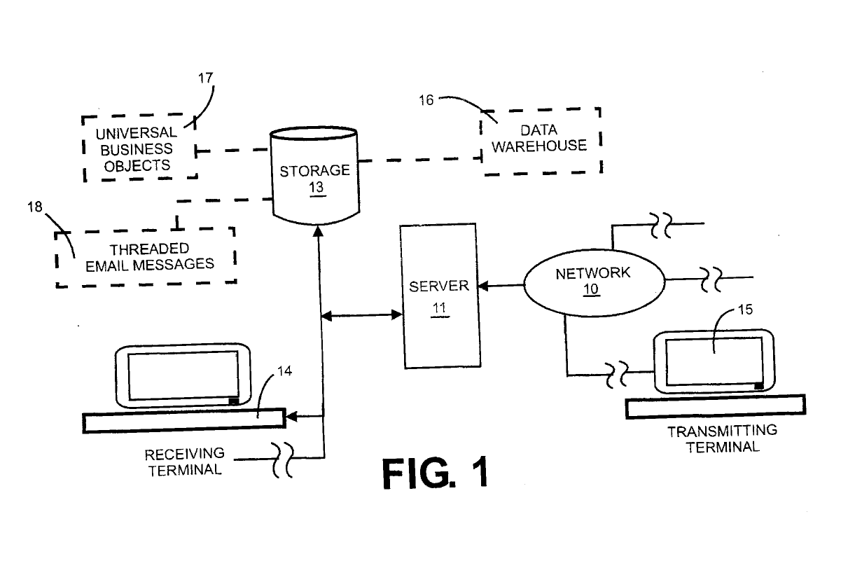

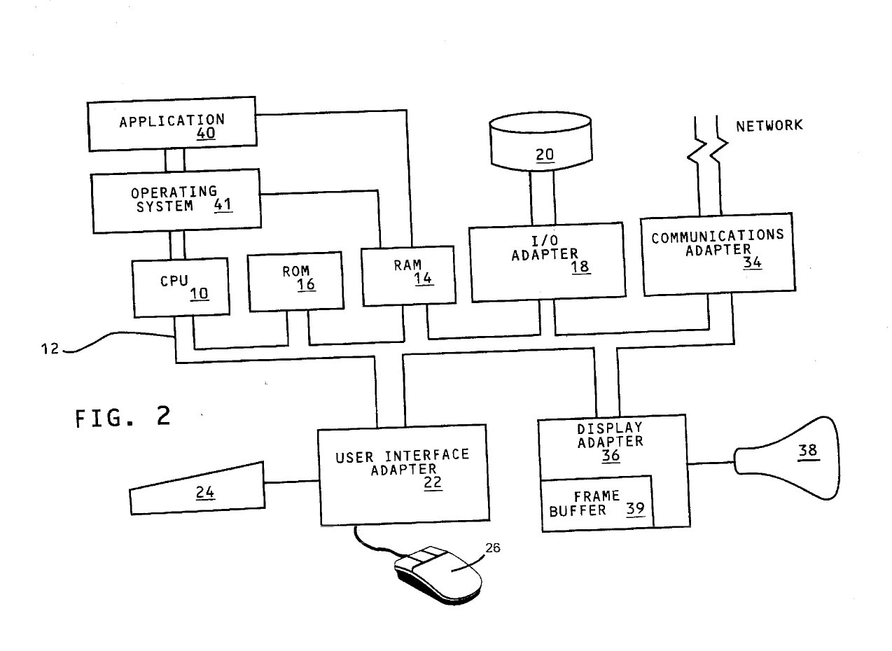

Referring to FIG. 1, there is shown a very generalized diagram of a Web portion on which the present invention may be implemented. The present invention may be implemented on any appropriate network for E-mail distribution. Receiving user computer station 14, having a user interactive display interface, controlled by a conventional Web browser program typically connected to the Web 10 via standard Web wired connections through Web access server 11 that may be provided by a commercial service provider. The E-mail message is sent from a transmitting terminal 15. As will be hereinafter described, the received E-mail message is subjected to an ontological semantic analysis based upon a Business Information (BI) system relevant to the user at receiving terminal 14. Such a BI system is constructed to support terminal 14 and related terminals by extracting, transforming data being dispersed in relevant enterprise information systems (EIS) into a DW 16 in storage apparatus 13. Such BI system formation is based upon predefined requirements of the system 14 receiving the E-mail. The BI system is further developed by linking appropriate analytical engines, ad-hoc reporting systems, as well as appropriate on-line analytical processing systems (OLAP) and data mining (DM) engines that may be accessed through the Web 10 via server 11. The resulting BI is stored in DW 16. Also in storage 13 are threaded E-mail messages 18 and universal business objects appropriate to the receiving station 14 that will be considered hereinafter.

With respect to FIG. 2, there is shown an illustrative diagrammatic view of a data processing system including a central processing unit and network connections via a communications adapter that is capable of functioning as users' computer controlled display stations and as the server for accessing the Web network. A central processing unit (CPU) 30, such as one of the microprocessors, e.g. from System p series available from International Business Machines Corporation (IBM), is provided and connected to various other components by system bus 12. An operating system 41 runs on CPU 10, provides control and is used to coordinate the function of the various components of FIG. 2. Operating system 41 may be one of the commercially available operating systems. Application programs 40 including the programs of the present invention for displaying business objects related to the context of received E-mail messages function in the client receiving station 14. These application programs are moved into and out of the main memory Random Access Memory (RAM) 44. These programming applications may be used to implement functions of the present invention. ROM 46 includes the Basic Input/Output System (BIOS) that controls the basic computer functions of Web station 14 or server 11. RAM 44, storage adapter 48 and communications adapter 34 are also interconnected to system bus 12. Storage adapter 48 communicates with the disk storage device 20. Communications adapter 34 interconnects bus 12 with the outside Web. I/O devices, e.g. mouse 26, are also connected to system bus 12 via user interface adapter 25. Optionally, a keyboard 24 may be connected to bus 12 through user interface adapter 25. Display buffer 39 connected through display adapter 36 to bus 12 supports display 38.

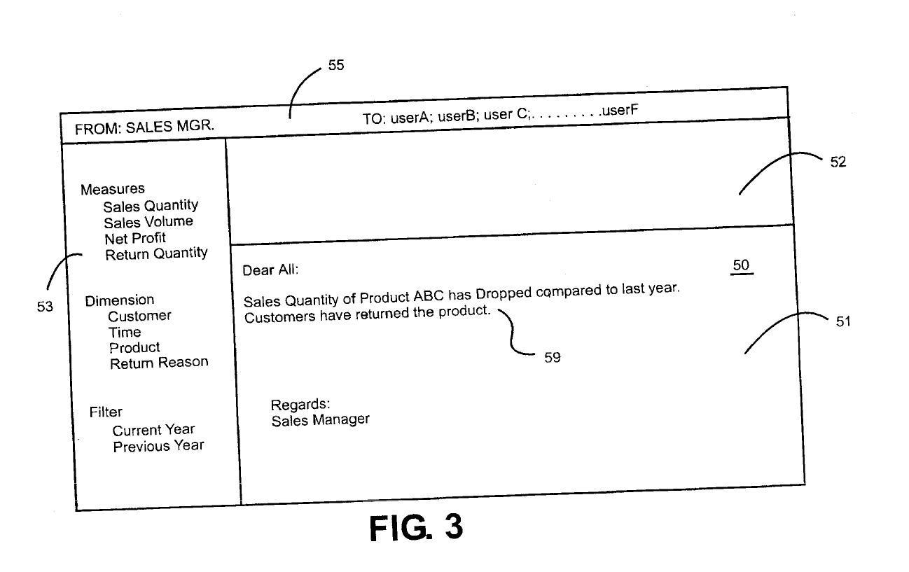

FIG. 3 is a generalized diagram of the display screen at a receiving user's display screen illustrating the displayed E-mail message together with a set of suggested business objects in accordance with this invention. The E-mail message 51 is displayed on display screen 50. The address line 55 indicates that the note is from the Sales Manager directed to a group of users. In the present illustration, this is the display terminal or station of User A at terminal 14 of FIG. 1. After the incoming E-mail message 51 has been analyzed as is being described herein, a set of suggested business objects 53 is displayed along with the E-mail message 51.

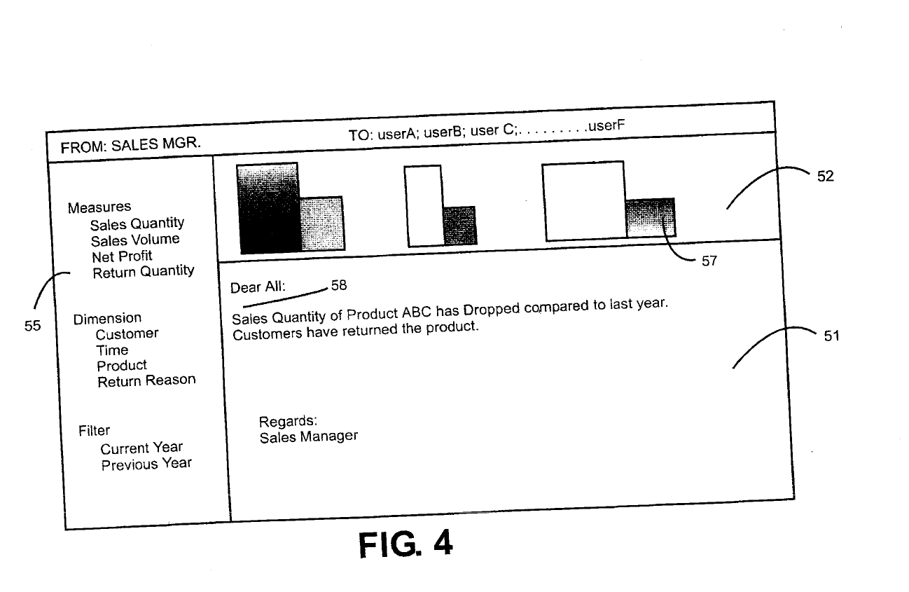

Also, as shown in the display of FIG. 4, there may be displayed in area 52 graphics 57 wherein the E-mail content 58 has been analyzed and a graph has been developed and displayed as part of an ad-hoc report.

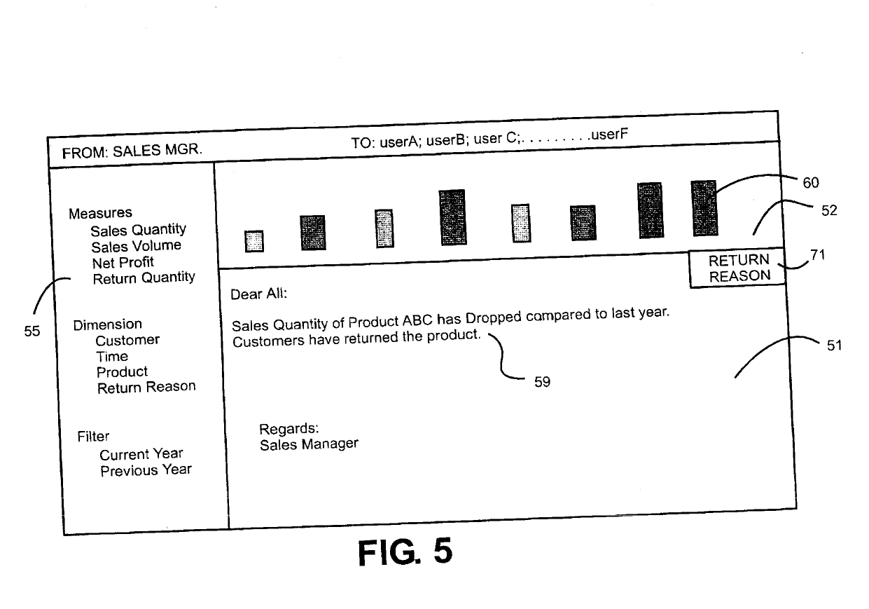

Similarly, as shown in the display of FIG. 5, there may also be displayed in area 52 graphics 60 wherein the user has input additional information: the reason for the item return 71, responsive to which another graph 60 has been developed and displayed ad-hoc based upon this user supplementary information.

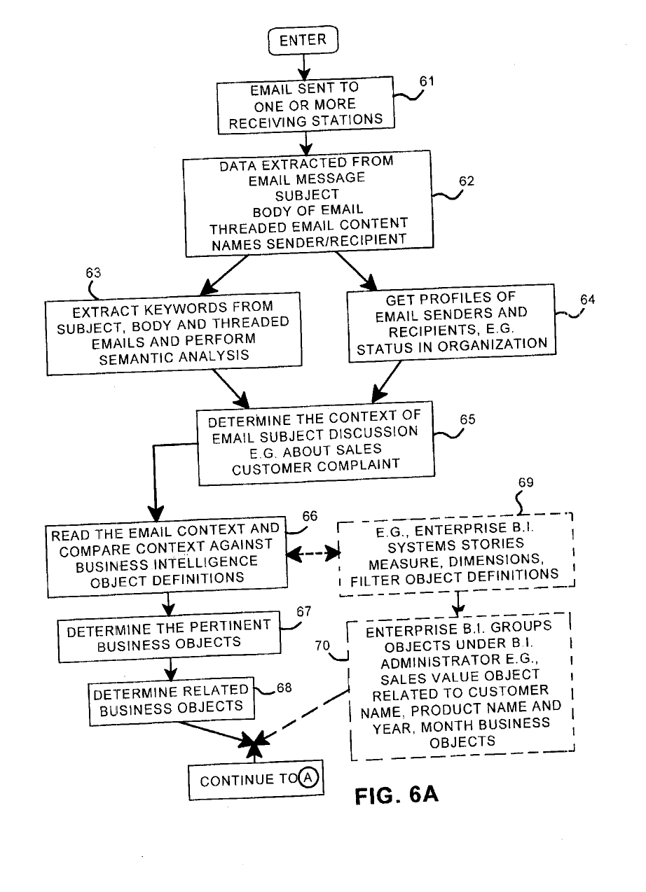

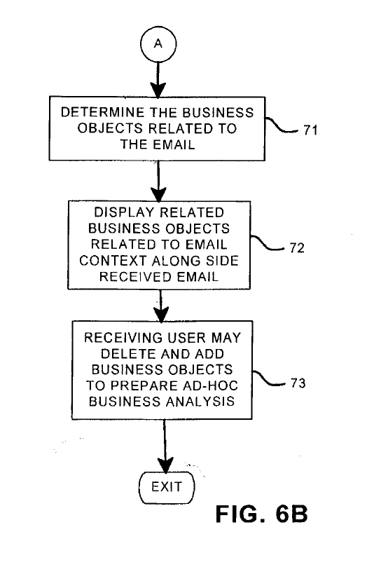

There will now be described with respect to FIG. 6A and continued on FIG. 6B an illustrative flowchart describing the running of the process of the present invention for showing how suggested intelligent data objects may be displayed together with the E-mail message. These figures will correlate what has been previously described in FIGS. 1 through 5 into a comprehensive description of this invention. An E-mail message is sent to one or more receiving stations, step 61. Data is extracted from the E-mail message 62, names of sender and receiver, including the subject, the message body content and possible connections to files or libraries of content threaded to the subject or content of the current E-mail message. Key words are extracted, step 63, from the subject, body and from threaded E-mail and a semantic analysis is performed on this data. The semantic analysis is preferably ontological.

In a threaded library or files, E-mail messages are grouped in a hierarchy by topic with any replies to the E-mail messages, arranged visually close to the specific message.

A basic ontology based system for BI objects provides, in addition to existing structural linked data, an ontology based logical communication channel and architecture that integrates reporting systems with a DW and EIS and the reporting systems. The ontology systems use ontological development techniques that may include ontology namespace, semantic relationships, ontological transformation, mapping, discovery and query for combining and transforming ontological items across systems.

Available profiles of E-mail senders and receivers, e.g. their status in the organization, are obtained, step 64, FIG. 6A. Then, step 65, the E-mail subject discussion is determined, e.g in the illustrated message of FIGS. 2 through 5, the context relates to sales and particularly to a customer complaint. The E-mail content is automatically read, step 66, and the content is compared against BI object definitions. As noted the Enterprise BI system stores in a DW and connected to said DW related Measure, Dimensions and Filter definitions, 69, and this EBI system groups objects under a BI Administrator, e.g. sales value objects, as well as objects related to customer name, product name and year/month business objects, 70.

Accordingly, step 67, the directly related business objects are determined, the potentially related business objects are determined, step 68, and, as continued via branch [A] to FIG. 6B, the set of business objects is determined, step 71, and the set of business objects related to the received E-mail message is displayed alongside the received message, step 72. The receiving user may then delete or add business objects or interactively manipulate the objects to develop and present ad hoc business analyses.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

What is claimed is:

1. In an electronic mail (E-mail) distribution network with user access via a plurality of data processor controlled interactive display terminals, a method for displaying business objects related to the context of received E-mail messages together with the E-mail messages comprising:
transmitting an E-mail message to at least one of the display terminals;
providing a set of suggested business objects to a display terminal receiving the E-mail message comprising:
profiling the person sending the E-mail message and the person receiving the E-mail message;
extracting key words from E-mail message content;
performing a semantic analysis of E-mail content; and
correlating the profiling, extracted key words and semantic analysis to provide the set of suggested business objects;
displaying the set of suggested business objects together with the E-mail message at a receiving display terminal; and
enabling a user at the receiving display terminal to interactively add or remove business objects to create an ad-hoc business analysis report.

2. The method of claim 1, wherein the providing the set of business objects further includes analysis of the content of E-mail messages threaded to the E-mail message.

3. The method of claim 1, wherein said E-mail message correlating includes:
correlating the profiling, extracted key words and semantic analysis to provide the E-mail message context; and
comparing the E-mail message context to a universal set of business objects to provide the specific set of suggested business objects.

4. The method of claim 1, wherein the performed semantic analysis is ontology based.

5. The method of claim 4, wherein the performed ontology based semantic analysis includes data mining.

6. The method of claim 4, wherein the performed ontology based semantic analysis includes accessing data from a data warehouse (DW) associated with the receiving display terminal.

7. The method of claim 1 further including displaying a set of most frequently used objects together with the displayed E-mail message and the set of suggested business objects.

8. In an electronic mail (E-mail) distribution network with user access via as plurality of data processor controlled interactive display terminals, a system for displaying business objects related to the context of received E-mail messages together with the E-mail messages comprising:
a processor; and
a computer memory holding computer program instructions that when executed by the processor perform the method comprising:
transmitting an E-mail message to at least one of the display terminals:
providing a set of suggested business objects to a display terminal receiving the E-mail message comprising:
profiling the person sending the E-mail message and the person receiving the E-mail message;
extracting key words from E-mail message content;
performing a semantic analysis of E-mail content; and
correlating the profiling, extracted key words and semantic analysis to provide the set of suggested business objects;
displaying the set of suggested business objects together with the E-mail message at a receiving display terminal; and
enabling a user at the receiving display terminal to interactively add or remove business objects to create an ad-hoc business analysis report.

9. The system of claim 8, wherein the method step providing the set of bus mess objects further includes analysis of the content of E-mail messages threaded to the E-mail message.

10. The system of claim 8, wherein said E-mail message correlating in the performed method includes:
correlating the profiling, extracted key words and semantic analysis to provide the E-mail message context; and
comparing the E-mail message context to a universal set of business objects to provide the specific set of suggested business objects.

11. The system of claim 8, wherein the performed semantic analysis is ontology based.

12. The system of claim 11, wherein the performed ontology based semantic analysis includes data mining.

13. The system of claim 11, wherein the performed ontology based semantic analysis includes accessing data from a data warehouse (DW) associated with the receiving display terminal.

14. The system of claim 8, wherein said performed method further includes displaying a set of most frequently used objects together with the displayed E-mail message and the set of suggested business objects.

15. A computer readable storage medium having stored thereon a computer readable program for displaying business objects related to the context of received E-mail messages together with the E-mail messages in an E-mail distribution network with user access via a plurality of data processor controlled interactive display terminals, wherein the computer readable program when executed on a computer causes the computer to:
transmit an E-mail message to at least one of the display terminals;
provide a set of suggested business objects to a display terminal receiving the E-mail message comprising:
profiling the person sending the E-mail message and the person receiving the E-mail message;
extract key words from E-mail message content;
perform a semantic analysis of E-mail content; and
correlate the profiling, extracted key words and semantic analysis to provide the set of suggested business objects;
display the set of suggested business objects together with the E-mail message at a receiving display terminal; and
enable a user at the receiving display terminal to interactively add or remove business objects to create an ad-hoc business analysis report.

16. The computer readable storage medium of claim 15, wherein the computer program when executed causes the computer to provide the set of business objects by further analyzing the content of e-mail messages threaded to the E-mail message.

17. The computer readable storage medium of claim 15, wherein the computer program when executed on a computer further causes the computer to correlate said E-mail message including:
correlating the profiling, extracted key words and semantic analysis to provide the E-mail message context; and
comparing the E-mail message context to a universal set of business objects to provide the specific set of suggested business objects.

18. The computer readable storage medium of claim 15, wherein the performed semantic analysis is ontology based.

19. The computer readable storage medium of claim 18, wherein the performed ontology based semantic analysis includes data mining.

20. The computer readable storage medium of claim 18, wherein the performed ontology based semantic analysis includes accessing data from a data warehouse (DW) associated with the receiving display terminal.

21. The computer readable storage medium of claim 15 wherein said computer program when executed further causes the computer to display a set of most frequently used objects together with the displayed E-mail message and the set of suggested business objects.
